(19) United States
(12) Patent Application Publication
(10) Pub. No.: US 2025/0022095 A1
(43) Pub. Date: Jan. 16, 2025

(54) UPSCALING VIDEO DATA

(71) Applicant: Microsoft Technology Licensing, LLC, Redmond, WA (US)

(72) Inventors: Adam Benjamin MESHI, Herzliya (IL); Ori LASLO, Rehovot (IL); Nadav LINENBERG, Even Yehuda (IL)

(73) Assignee: Microsoft Technology Licensing, LLC, Redmond, WA (US)

(21) Appl. No.: 18/350,975

(22) Filed: Jul. 12, 2023

(51) Int. Cl. G06T 3/40; G06V 10/74; G06V 10/75

(52) U.S. Cl. CPC G06T 3/4053; G06V 10/751; G06V 10/761

(57) ABSTRACT

Computing devices and methods of upscaling video data are disclosed. In one example a method of upscaling video data comprises generating first resolution video data comprising a plurality of tiles that each comprise a plurality of pixels. The method determines whether a first tile of the plurality of tiles matches a previously-received version of the first tile. At least on condition that the first tile does not match the previously-received version of the first tile, the first tile is upscaled from a first resolution to a second resolution greater than the first resolution. The method determines whether a second tile of the plurality of tiles matches a previously-received version of the second tile. At least on condition that the second tile matches the previously-received version of the second tile, the method refrains from upscaling the second tile from the first resolution to the second resolution.

### BACKGROUND

Streaming video can be delivered to a receiving device in a lower resolution and upscaled by the device for display. Upscaling solutions can utilize substantial processing and power resources.

### SUMMARY

As described in more detail below and according to one aspect of the present disclosure, a method of upscaling video data comprises generating first resolution video data comprising a plurality of tiles. The method determines whether a first tile matches a previously-received version of the first tile. At least on condition that the first tile does not match the previously-received version, the first tile is upscaled from a first resolution to a greater second resolution. The method determines whether a second tile matches a previously-received version of the second tile. At least on condition that the second tile matches the previously-received version, the method refrains from upscaling the second tile from the first resolution to the second resolution.

Another aspect provides a computing device, comprising a processor and memory storing instructions executable by the processor to: generate first resolution video data comprising a plurality of tiles; determine whether a first tile of the plurality of tiles matches a previously-received version of the first tile; at least on condition that the first tile does not match the previously-received version of the first tile, upscale the first tile from a first resolution to a second resolution greater than the first resolution; determine whether a second tile of the plurality of tiles matches a previously-received version of the second tile; and at least on condition that the second tile matches the previously-received version of the second tile, refrain from upscaling the second tile from the first resolution to the second resolution.

Another aspect provides a computing device configured to upscale video data, the computing device comprising a display and a processor. Memory stores instructions executable by the processor to: generate first resolution video data comprising a plurality of tiles; determine whether a first tile of the plurality of tiles matches a previously-received version of the first tile; at least on condition that the first tile does not match the previously-received version of the first tile, upscale the first tile from a first resolution to a second resolution greater than the first resolution and write the upscaled first tile to an output buffer to replace a prior upscaled version of the previously-received version of the first tile; determine whether a second tile of the plurality of tiles matches a previously-received version of the second tile; at least on condition that the second tile matches the previously-received version of the second tile, refrain from upscaling the second tile from the first resolution to the second resolution and maintain a prior upscaled version of the second tile in the output buffer; and write data from the output buffer including the upscaled first tile and the prior upscaled version of the second tile to the display.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a computing device configured to upscale video data according to examples of the present disclosure.

FIGS. 2A and 2B show a block diagram of an example method of upscaling video data according to examples of the present disclosure.

FIG. 3 is a schematic diagram of a plurality of tiles of first resolution video data in a current frame, previously-received versions of the tiles, and an output buffer comprising upscaled versions of the tiles.

FIG. 4 is a schematic diagram showing upscaled tiles being written to the output buffer.

FIG. 5 is a schematic diagram showing an unmatching tile comprising noise being reused in the output buffer.

FIG. 6 is a schematic diagram of a plurality of tiles of first resolution video data with some tiles comprising a pixel difference, and an output buffer comprising previously-received upscaled versions of the tiles.

FIG. 7 is a schematic diagram showing upscaled tiles being written to the output buffer.

FIG. 8 is a schematic diagram of a supertile comprising a plurality of tiles of first resolution video data and an output buffer comprising previously-received upscaled versions of the tiles.

FIG. 9 is a schematic diagram showing the tiles of the supertile being upscaled and written to the output buffer.

FIG. 10 shows a block diagram of an example computing system.

### DETAILED DESCRIPTION

To reduce bandwidth and video rendering processing requirements, video is compressed and streamed in a lower resolution to a receiving device. The receiving device can decode and upscale the video data to a higher resolution for improved video quality for display. In examples where video is locally generated on a device, the video data can be similarly upscaled. However, upscaling solutions for video, such as Super Resolution, can utilize substantial processing and power resources of the receiving device.

To address one or more of these issues, examples are disclosed that relate to upscaling techniques that selectively upscale tiles comprising new information and selectively reuse previously-received tiles. Advantageously and as described in more detail below, computing devices and methods of the present disclosure selectively upscale video data in a manner that improves processing efficiency and reduces power consumption of the receiving device.

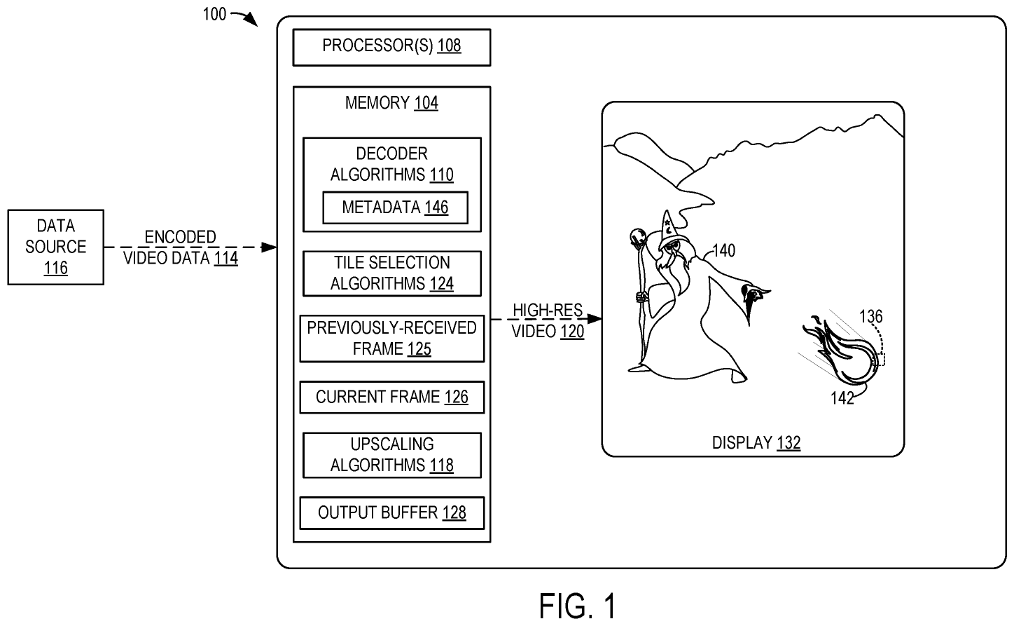

With reference now to FIG. 1, a computing device configured to upscale video data according to examples of the present disclosure is illustrated. In some examples, the computing device 100 comprises a tablet computing device, smartphone, wearable computing device such as a head-mounted display, or other portable computing device. In other examples, the systems and methods of the present disclosure may be utilized in a variety of other devices, including but not limited to monitors, televisions, and automotive displays.

Computing device 100 includes memory 104 that stores instructions executable by one or more processor(s) 108. Such instructions can include an operating system and one or more applications. In the present example and as described in more detail below, the memory 104 stores instructions in the form of video decoder algorithms 110 executable by the processor(s) 108 to receive encoded video data 114 from an external data source 116 and generate low-resolution digital video data. In other examples, a processor 108 such as a graphics processing unit (GPU) can locally generate the low-resolution digital video data.

Memory 104 also stores instructions in the form of video upscaling algorithms 118 executable by the processor(s) 108 to upscale tiles of the video data from a first (low) resolution to a second resolution greater than the first resolution. For example, the encoded video data 114 may have a 720p resolution (1280×720 pixels), and the high-resolution video 120 generated by the upscaling algorithms 118 may have a 4K resolution (3840×2160 pixels). In other examples, any suitable lower and higher resolutions may be utilized. The high-resolution video data 120 is delivered to a display 132 for display.

As described in more detail below, each frame of the first resolution video data comprises a plurality of tiles, with each tile comprising a plurality of pixels. For example, each tile can be composed of a 100×100 array of pixels arranged in a square. In other examples, tiles can comprise any suitable number or pixels arranged in any suitable shapes.

Additionally, and as described in more detail below, memory 104 stores instructions in the form of tile selection algorithms 124 executable by the processor(s) 108 to determine whether tiles of the video data in a current frame 126 match previously-received versions of the tiles stored in memory. Where a tile matches a previously-received version of the tile, the tile selection algorithms 124 refrain from upscaling the tile and maintain a prior upscaled version of the second tile in the output buffer 128. Where a tile does not match a previously-received version of the tile, the tile selection algorithms 124 upscale the tile and write the upscaled tile to the output buffer 128 to replace a prior upscaled version of the previously-received version of the tile.

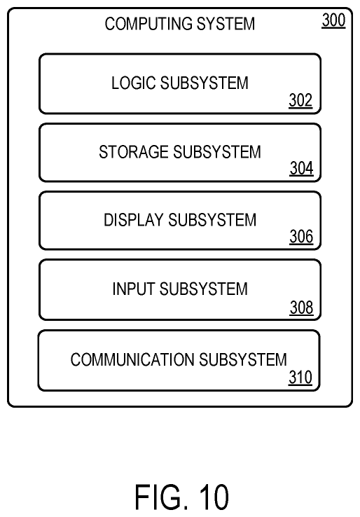

Advantageously, by selectively reusing tiles that match previously-received tiles, the present disclosure can upscale less than all of the tiles in a video frame, thereby significantly improving processing efficiency and reducing power consumption and computational load of the computing device. Additional details regarding memory 104, processor(s) 108, tile selection algorithms 124, and other components, subsystems, and algorithms of computing device 100 are described further below with reference to FIG. 10.

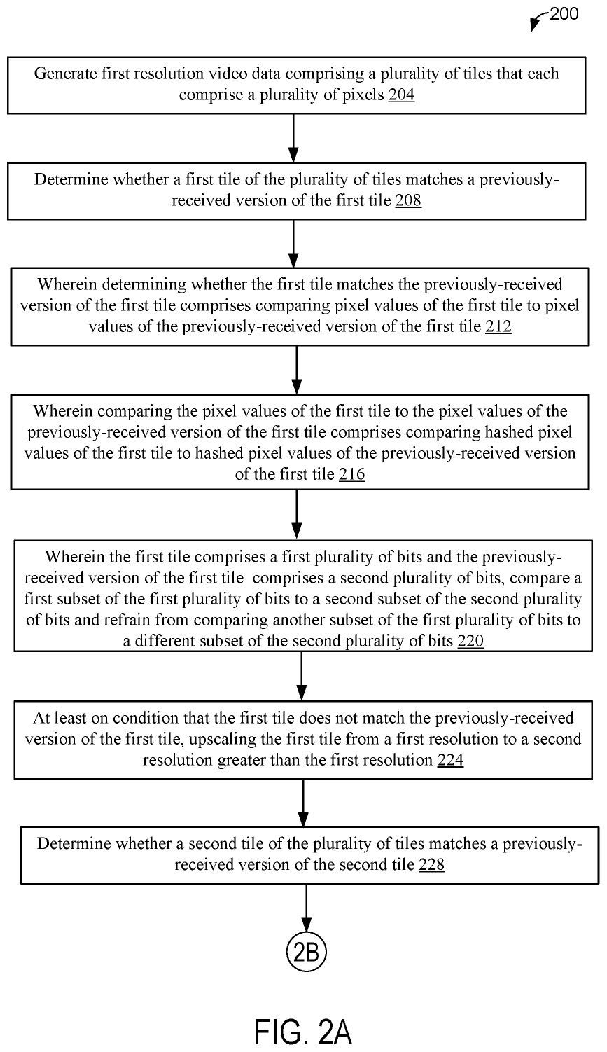

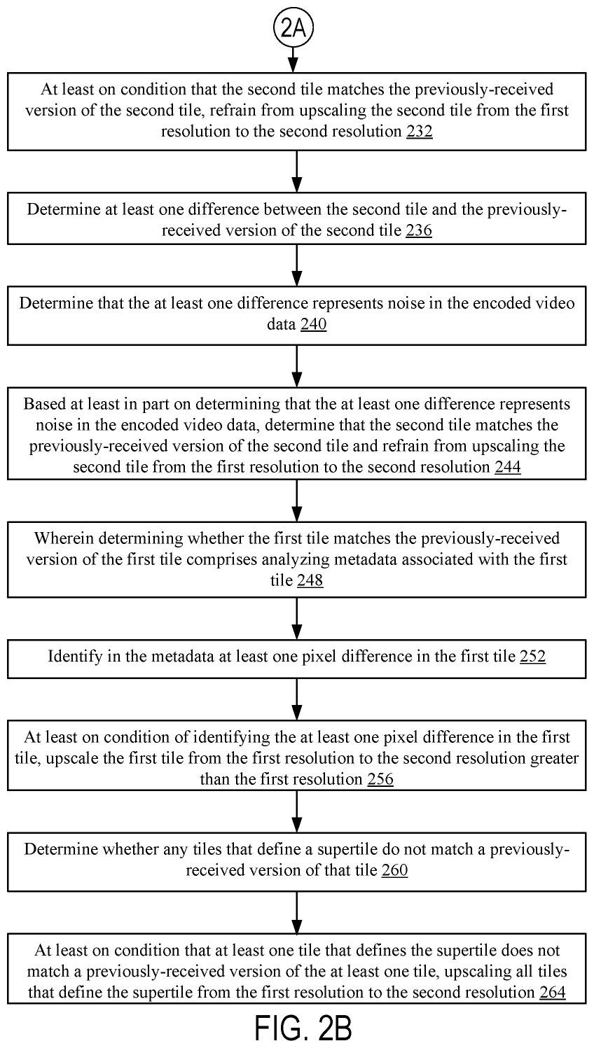

With reference now to FIGS. 2A-2B, a flow diagram is provided depicting an example method 200 of upscaling video data according to examples of the present disclosure. The following description of method 200 is provided with reference to the computing device 100 and related components described herein and shown in FIGS. 1 and 3-10. In other examples, the method 200 can be performed with other computing devices and in other contexts using other suitable devices and components.

At 204, the method 200 includes generating first resolution video data comprising a plurality of tiles that each comprise a plurality of pixels. The video data can be received in a plurality of frames of video data, with each frame comprising a plurality of pixels, such as 1280×720 pixels. The tile selection algorithms 124 can partition each frame into a plurality of tiles that each comprise a plurality of pixels, such as 100×100 pixels. In one potential advantage of the present disclosure, and as described in more detail below, the tile selection algorithms 124 compare tiles in a current frame with corresponding tiles in a previously-received frame to determine whether a current tile matches a corresponding previously-received version of that tile. Where a current tile matches the previously-received version of the tile, the tile selection algorithms 124 refrain from upscaling this tile and maintain and reuse the existing upscaled version of the second tile in the output buffer, thereby conserving processing and power resources.

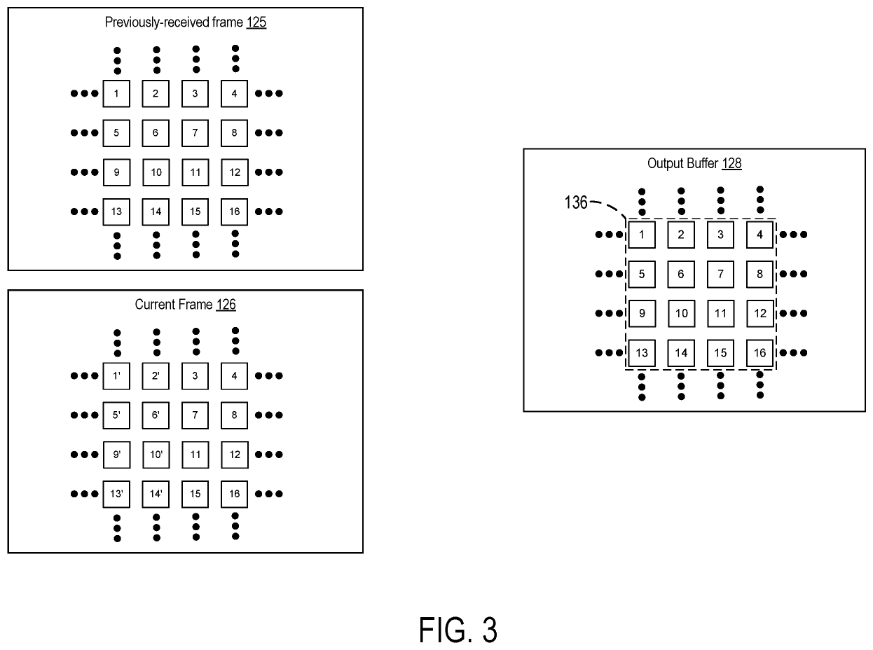

With reference now to FIG. 3, a plurality of tiles numbered 1-16 from a current frame 126 of the low (first) resolution video data are schematically illustrated. In this example the tiles 1-16 correspond to a portion 136 of the upscaled higher-resolution image shown on display 132 in FIG. 1. The portion 136 is enlarged in FIG. 1 for ease of description. FIG. 3 also schematically depicts previously-received, low (first) resolution versions of tiles 1-16 from the previously-received frame 125 stored in memory 104.

In this example, each frame of the low (first) resolution video data is partitioned into a plurality of tiles that each include a plurality of pixels. In one example, each tile is composed of a 20×10 array of pixels arranged in a rectangle. In an example in which each frame of low (first) resolution video data includes 921,600 pixels (1280×720 pixels), each frame in this example is partitioned into 4,608 tiles (each comprising a 20×10 array of pixels). In other examples any suitable numbers of pixels per tile, any suitable numbers of tiles per frame, and/or any suitable shapes of tiles and pixel groupings may be utilized. In some examples and to improve performance and quality, each frame can be partitioned into tiles that overlap one another, such as a plurality of 20×10 pixel tiles in which neighboring tiles overlap and share 10 pixels between the tiles.

In some examples the size and/or shape of the tiles can be predetermined, with the upscaling algorithms 118 (such as a Super Resolution algorithm) trained for the predetermined tile size and shape. In different examples, the tile size and/or shape can be optimized for the upscaling algorithms 118 and/or tile selection algorithms 124 that are utilized. In some examples, the tile size, shape and/or location can be updated at runtime to provide additional reductions in processing and power consumption. In one example, a portion of the display 132 is displaying a working window in which the content is changing (such as a movie), and different content outside of the working window is not changing. To advantageously minimize the number of tiles needing to be updated, the system can organize the tiles so that the window borders align with the tile borders. For example, the system can select a tile size, shape and/or location so that the window borders align with the tile borders. In this manner, further reductions in processing resources can be realized.

In the example of FIG. 3 and as noted above, the tiles 1-16 from the current frame 126 of the low (first) resolution video data are depicted. FIG. 3 also schematically illustrates the output buffer 128 and the portion 136 of the upscaled higher-resolution image shown on display 132 in FIG. 1, which portion also corresponds to tiles 1-16 in the previously-received frame 125. In this example, the frame in the output buffer 128 has been written to the display 132 such that the image on the display represents the output buffer frame. The current frame 126 represents the next frame subsequent to this frame in the output buffer 128. The previously-received frame 125 represents the frame of low (first) resolution video data immediately preceding the current frame 126.

In some examples, the entire contents of the current low (first) resolution frame 126 are held in memory as a whole frame. In other examples, the entire contents of the current low (first) resolution frame 126 are not simultaneously held in memory as a whole frame. In these examples, the memory contains a portion of the current frame 126 at any given time (i.e., a few tiles), with some or all of these tiles then passed on to the upscaling algorithms 118, and then replaced in memory with more tiles of the current frame. Additionally, in some examples the output buffer 128 is used as a single buffer containing the high (second) resolution frame that is currently being displayed on the screen. In other examples, the output buffer 128 is used as a double buffer comprising one portion containing the high resolution frame being read by the display controller and currently displayed, and a second portion containing portions of or the entire next high resolution frame being written by the upscaling algorithms 118.

In the example of FIG. 1, the display 132 is shown displaying a frame of streaming video comprising upscaled image data of a wizard 140 casting a flaming ball 142 in front of a mountainous backdrop. In the next frame of the streaming video, a portion of which is shown in current frame 126 in FIG. 3, the fireball 142 has moved slightly further away from the wizard's hand. Accordingly and with reference to the portion 136 of the upscaled higher-resolution image shown in FIG. 1 and depicted in the output buffer 128 of FIG. 3, this slight displacement of the fireball 142 in the next frame (current frame 126) will be represented by changes in the pixels of left-side tiles 1, 2, 5, 6, 9, 10, 13, and 14 as compared to these pixels in the previously-received frame 125. These changes are schematically shown in left-side tiles 1′, 2′, 5′, 6′, 9′, 10′, 13′, and 14′ of the current frame 126 in FIG. 3.

With reference also to FIG. 1, the right-side tiles of the portion 136 of the upscaled higher-resolution image are depicting portions of the mountainous backdrop behind the fireball 142 that do not change from the previously-received frame in the output buffer 128 to the current frame 126. Accordingly, in the next frame of the streaming video (current frame 126) with the fireball 142 displaced just slightly further from the wizard's hand, the pixels in these right-side tiles 3, 4, 7, 8, 11, 12, 15, and 16 in the next frame will be substantially or entirely unchanged from pixels in the corresponding right-side tiles of the previously-received versions of these tiles in the previously-received frame 125.

Accordingly, in one potential advantage of the present disclosure and as described further below, the tile selection algorithms 124 selectively reuse previously-received tiles in a previous frame that match tiles in a current frame, and correspondingly refrain from upscaling those matching tiles in the current frame. In one example and with reference again to FIG. 2A, at 208 the method 200 includes determining whether a first tile of the plurality of tiles matches a previously-received version of the first tile. For example and with reference again to FIG. 3, the tile selection algorithms 124 can determine whether tile 1′ in the current frame 126 matches the previously-received version of this tile in the previously-received frame 125, tile 1.

In one example and with reference again to FIG. 2A, at 212 determining whether a first tile matches the previously-received version of the first tile comprises comparing pixel values of the first tile to pixel values of the previously-received version of the first tile. At 216 comparing the pixel values of the first tile to the pixel values of the previously-received version of the first tile comprises comparing hashed pixel values of the first tile to hashed pixel values of the previously-received version of the first tile. For example, the tile selection algorithms 124 can apply a hash function to tile 1′ in the current frame 126 and to the previously-received version tile 1 in the previously-received frame 125. Where the generated hash values of both tiles are not identical, the tile selection algorithms 124 determine tile 1′ in the current frame 126 does not match the previously-received version of tile 1 in the previously-received frame 125.

In some examples where tiles comprise a plurality of bits, at 220 the method 200 includes comparing a first subset of a first plurality of bits of a first tile to a second subset of a second plurality of bits of a previously-received version of the first tile, and refraining from comparing another subset of the first plurality of bits to a different subset of the second plurality of bits. In one example, where each pixel includes 3 color channels of 8 bits each, the method can compare 6 of the 8 bits for each channel. In these examples, comparing fewer than all of the bits of each tile can provide a more flexible and realistic comparison between two tiles that still identifies tiles that differ materially, while also increasing the quantity of matching tiles. In this manner, and in another potential advantage of the present disclosure, the reuse of previously-received tiles can be further increased to drive further processing efficiencies and reduced power requirements.

In other examples, a variety of other methods of comparing pixel values of tiles to determine whether a current tile matches a previously-received version of that tile can be utilized. For example, checksums, cyclic redundancy checks, and other error-detecting algorithms can be utilized.

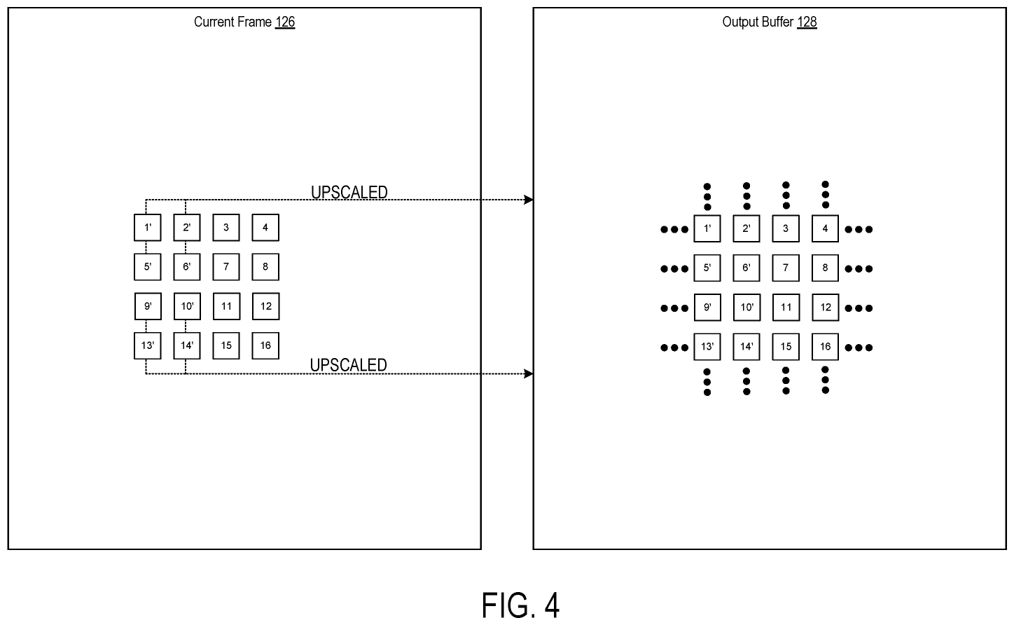

With reference again to FIG. 2A and at 224, at least on condition that the first tile does not match the previously-received version of the first tile, the method 200 includes upscaling the first tile from a first resolution to a second resolution greater than the first resolution. With reference now to FIG. 3 and as noted above, one or more pixels in each of the left-side tiles 1′, 2′, 5′, 6′, 9′, 10′, 13′, and 14′ in the current frame 126 have been identified as being different from corresponding pixels in corresponding tiles 1, 2, 5, 6, 9, 10, 13, and 14 in the previously-received frame 125. Accordingly and as depicted in FIG. 4, each of the left-side tiles 1′, 2′, 5′, 6′, 9′, 10′, 13′, and 14′ are upscaled and written to the output buffer 128 to replace the prior upscaled versions of these tiles in the buffer. In this manner, and in another potential advantage of the present disclosure, the tiles in the current frame that have new information are upscaled and written to the output buffer 128 to replace the prior upscaled versions of these tiles.

At 228 the method 200 also includes determining whether a second tile of the plurality of tiles matches a previously-received version of the second tile. With reference now to FIG. 2B, at 232 and in another potential advantage of the present disclosure, the method 200 includes, at least on condition that the second tile matches the previously-received version of the second tile, refraining from upscaling the second tile from the first resolution to the second resolution, and maintaining the upscaled version of the second tile in the output buffer.

For example and with reference again to FIG. 3, each of the right-side tiles 3, 4, 7, 8, 11, 12, 15, and 16 in the current frame 126 are determined to match the corresponding tiles 3, 4, 7, 8, 11, 12, 15, and 16 in the previously-received frame 125. As shown in FIG. 1 and as noted above, the right-side tiles of the portion 136 of the upscaled higher-resolution image are depicting portions of the mountainous backdrop behind the fireball 142 that do not change from the previously-received frame in the output buffer 128 to the current frame 126. Accordingly, in the next frame (current frame 126) of the streaming video with the fireball 142 displaced just slightly further from the wizard's hand, the pixels in these right-side tiles in the next frame will be substantially or entirely unchanged from pixels in the corresponding right-side tiles of the previously-received versions of these tiles in the previously-received frame 125.

Accordingly and as depicted in FIG. 4, because these right-side tiles match the previously-received versions of these tiles, the method refrains from upscaling these tiles from the first resolution to the second resolution, and correspondingly maintains the previously-upscaled versions of these tiles in the output buffer 128. In this manner, and in another potential advantage of the present disclosure, by reusing the previously-upscaled versions of these tiles, the additional processing resources and power requirements that would otherwise be incurred in upscaling and writing these tiles to the output buffer 128 is saved. It also follows that in this example, to generate an upscaled image that accurately represents the low-resolution image of the current frame 126, only presently-upscaled tiles 1′, 2′, 5′, 6′, 9′, 10′, 13′, and 14′ are required to be written to the output buffer 128, thereby further conserving resources. The contents of the output buffer 128 are then written to the display 132.

In some examples, the tile selection algorithms 124 can identify that a difference between a tile and a previously-received version of the tile represents noise in the video data as opposed to other differences that correspond to substantive changes between frames of the image data. At 236 the method 200 includes determining at least one difference between a second tile and the previously-received version of the second tile. At 240 the method 200 includes determining that the at least one difference represents noise in the video data. For example, statistical techniques or wavelet transforms can identify pixels that are substantially different from neighboring pixels and likely represent noise. In other examples, frequency domain analyses can identify frequencies that are not present in the source video signal.

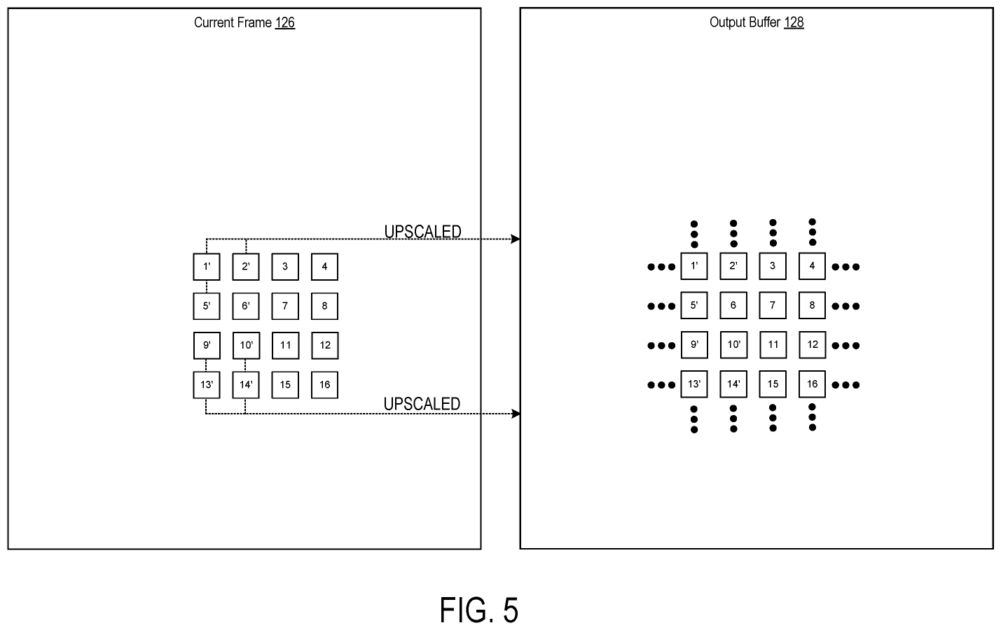

At 244 the method 200 includes, based at least in part on determining that the at least one difference represents noise in the video data, determining that the second tile matches the previously-received version of the second tile and refraining from upscaling the second tile from the first resolution to the second resolution. In one example and with reference to FIG. 3, the tile selection algorithms 124 determine that the difference between tile 6′ in the current frame 126 and the previously-received version of the tile 6 in the previously-received frame 125 represents noise in the video data 114. Accordingly and with reference to FIG. 5, the tile selection algorithms 124 can refrain from upscaling tile 6′ and from writing a new upscaled tile 6′ to the output buffer 128, and instead simply reuse the previously-upscaled tile 6 that is already saved in the output buffer. In this manner, and in another potential advantage of the present disclosure, further processing and power savings can be realized by identifying differences between tiles that are attributable to noise as opposed to other differences that correspond to substantive changes between frames of the image data.

In some examples and with reference again to FIG. 1, metadata 146 from the decoder can be utilized to determine whether a first tile matches a previously-received version of the first tile. With reference again to FIG. 2B, at 248 the method 200 includes analyzing metadata associated with the first tile. At 252 the method 200 includes identifying in the metadata at least one pixel difference in the first tile, with such pixel difference representing at least one pixel containing data different from the data in the corresponding pixel in the previously-received version of first tile. At 256 the method 200 includes, at least on condition of identifying the at least one pixel difference in the first tile, upscaling the first tile from the first resolution to the second resolution greater than the first resolution.

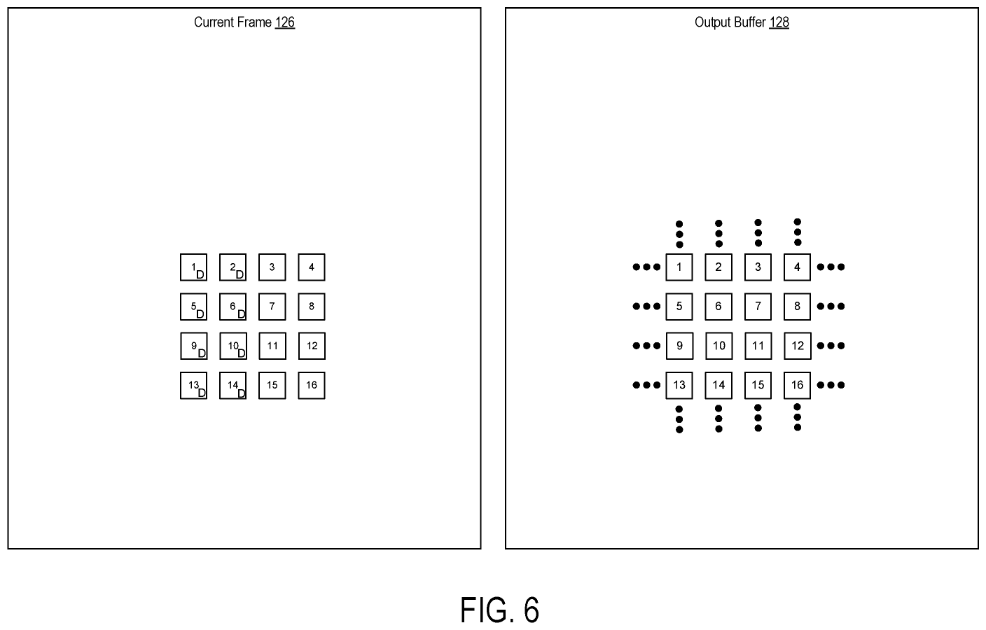

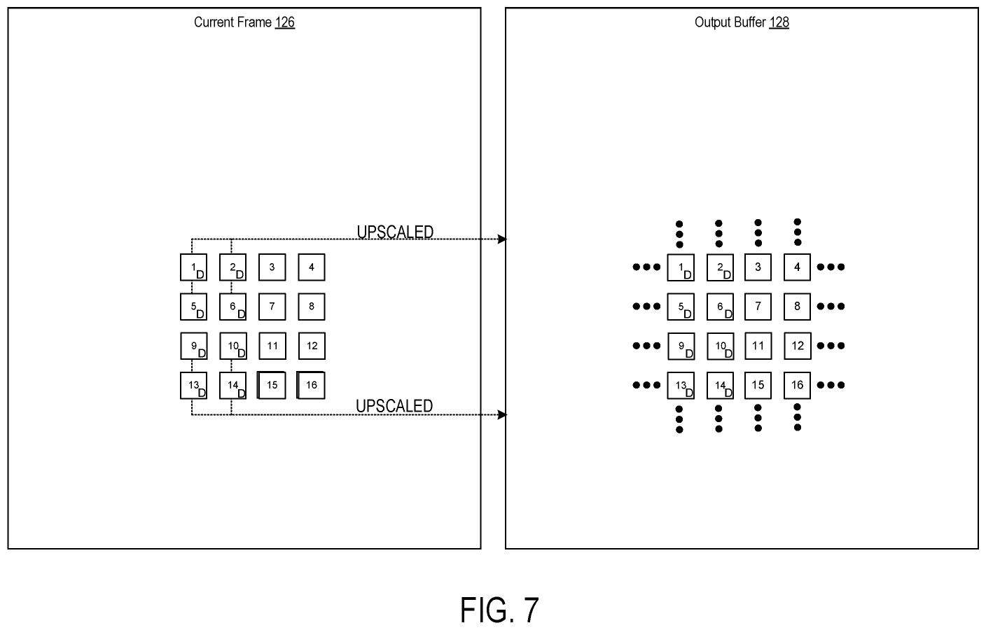

In one example and with reference now to FIG. 6, the tile selection algorithms 124 analyze the metadata 146 to determine that tiles 1_{D}, 2_{D}, 5_{D}, 6_{D}, 9_{D}, 10_{D}, 13_{D}, and 14_{D} in the current frame 126 each contain a pixel difference as compared to the corresponding pixels in the corresponding previously-received versions of each tile. Accordingly and as depicted in FIG. 7, at least on condition of identifying the pixel differences in each of the tiles 1_{D}, 2_{D}, 5_{D}, 6_{D}, 9_{D}, 10_{D}, 13_{D}, and 14_{D}, these tiles are upscaled and written to the output buffer 128 to replace the prior upscaled versions of the previously-received versions of these tiles in the buffer.

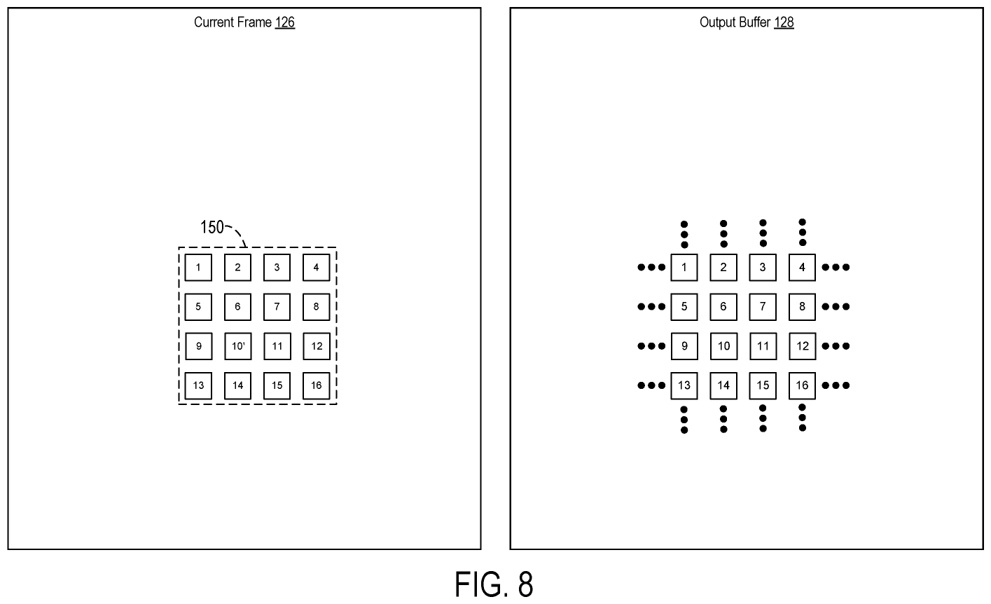

In some examples, the first resolution video data is partitioned into a plurality of supertiles, where each supertile is composed of two or more individual tiles. As noted above, each individual tile comprises a plurality of pixels, such as 100×100 pixels. With reference now to FIG. 8, in this example a supertile 150 of the first resolution video data is composed of 16 individual tiles. With reference again to FIG. 2B, at 260 the method 200 includes determining whether any tiles that define the supertile do not match a previously-received version of that tile. In the example of FIG. 8, the tile selection algorithms 124 use any of the methods discussed above to determine that tile 10′ does not match the previously-received version of this tile.

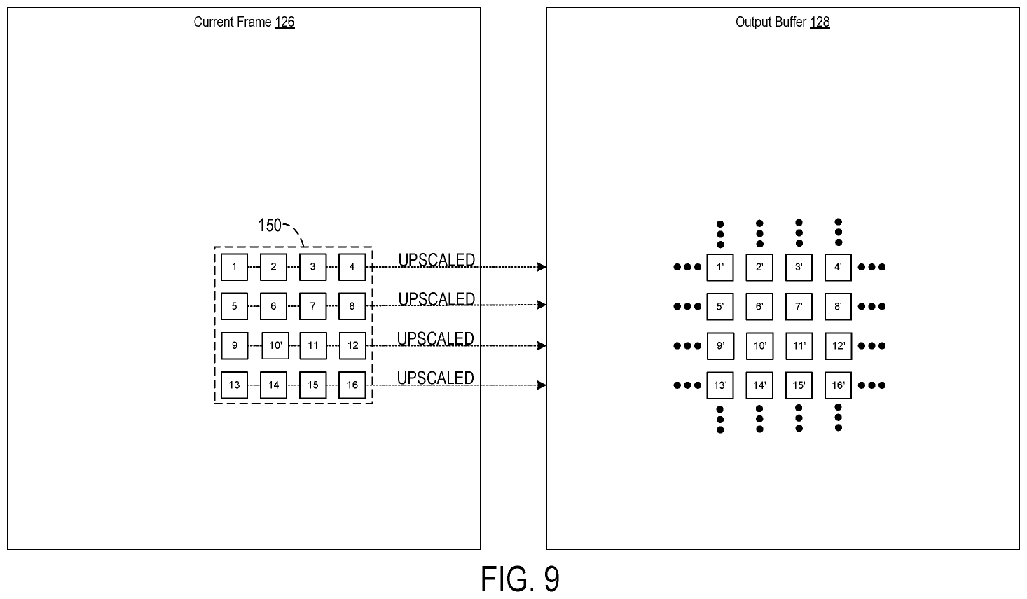

At 264 the method 200 includes, at least on condition that at least one tile that defines the supertile does not match a previously-received version of the at least one tile, upscaling all tiles that define the supertile from the first resolution to the second resolution. With reference now to FIG. 9, in this example, at least on condition of determining that tile 10′ does not match the previously-received version of this tile, all 16 tiles that define the supertile 150 are upscaled and written to the output buffer 128 to replace the previously-received versions of these tiles. Accordingly, and in one potential advantage of this example, by partitioning tiles into supertiles and selectively upscaling the supertiles as described above, the method can more efficiently determine whether to upscale multiple tiles comprising a supertile, with such determinations based on an analysis of a smaller number of those tiles in some examples. In this manner, fewer processing and/or memory resources can be utilized in generating an upscaled, higher resolution image in the output buffer 128.

In other examples, supertiles can be defined to contain any suitable number of individual tiles, and each individual tile can comprise any suitable number of pixels. Additionally, where the tile selection algorithms 124 determine that all pixels in all of the tiles of a supertile match the pixels in the previously-received versions of those tiles, none of the pixels in the tiles of the supertile in the current frame 126 are upscaled from the first resolution to the second resolution. Advantageously and in this case, the previously-upscaled versions of the tiles in the output buffer 128 are maintained and are written from the output buffer to the display.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 10 schematically shows a non-limiting embodiment of a computing system 300 that can enact one or more of the examples described above. For example, computing system 300 can be used to execute instructions to perform the method 200 of FIGS. 2A-2B and/or potentially perform other functions.

Computing system 300 is shown in simplified form. Computing system 300 can take the form of one or more personal computers, server computers, tablet computers, network computing devices, mobile computing devices, mobile communication devices (e.g., smart phone), wearable computing devices, and/or other computing devices. In some examples, the computing device 100 of FIG. 1 comprises one or more aspects of the computing system 300.

Computing system 300 includes a logic subsystem 302, a storage subsystem 304, and a display subsystem 306. Computing system 300 can optionally include an input subsystem 308, a communication subsystem 310, and/or other components not shown in FIG. 10.

Logic subsystem 302 includes one or more physical devices configured to execute instructions. For example, logic subsystem 302 can be configured to execute instructions that are part of one or more applications, services, programs, routines, libraries, objects, components, data structures, or other logical constructs. Such instructions can be implemented to perform a task, implement a data type, transform the state of one or more components, achieve a technical effect, or otherwise arrive at a desired result. For example, logic subsystem 302 can be used to execute instructions to perform the method 200 of FIGS. 2A-2B.

Logic subsystem 302 can include one or more processors and/or microcontrollers configured to execute software instructions. Additionally or alternatively, logic subsystem 302 can include one or more hardware or firmware logic machines configured to execute hardware or firmware instructions. Processors and microcontrollers of logic subsystem 302 can be single-core or multi-core, and the instructions executed thereon can be configured for sequential, parallel, and/or distributed processing. Individual components of logic subsystem 302 optionally can be distributed among two or more separate devices, which can be remotely located and/or configured for coordinated processing. Aspects of logic subsystem 302 can be virtualized and executed by remotely accessible, networked computing devices configured in a cloud-computing configuration.

Storage subsystem 304 includes one or more physical devices configured to hold instructions executable by logic subsystem 302 to implement the methods and processes described herein. For example, storage subsystem 304 can hold instructions executable to perform the method 200 of FIGS. 2A-2B, and/or potentially perform other functions. When such methods and processes are implemented, the state of storage subsystem 304 can be transformed—e.g., to hold different data.

Storage subsystem 304 can include removable and/or built-in devices. Storage subsystem 304 can include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage subsystem 304 can include volatile, nonvolatile, dynamic, static, read/write, read-only, random-access, sequential-access, location-addressable, file-addressable, and/or content-addressable devices.

It will be appreciated that storage subsystem 304 includes one or more physical devices. However, aspects of the instructions described herein alternatively may be propagated by a communication medium (e.g., an electromagnetic signal, an optical signal, etc.) that is not held by a physical device for a finite duration.

Aspects of logic subsystem 302 and storage subsystem 304 can be integrated together into one or more hardware-logic components. Such hardware-logic components can include field-programmable gate arrays (FPGAs), program- and application-specific integrated circuits (PASIC/ASICs), program- and application-specific standard products (PSSP/ASSPs), SoCs, and complex programmable logic devices (CPLDs), for example.

The terms “program” and “application” may be used to describe an aspect of computing system 300 implemented to perform a particular function. In some cases, a program or application may be instantiated via logic subsystem 302 executing instructions held by storage subsystem 304. It will be understood that different programs and applications may be instantiated from the same service, code block, object, library, routine, API, function, etc. Likewise, the same program or application may be instantiated by different services, code blocks, objects, routines, APIs, functions, etc. The terms “program” and “application” may encompass individual or groups of executable files, data files, libraries, drivers, scripts, database records, etc.

Display subsystem 306 can be used to present a visual representation of data held by storage subsystem 304. This visual representation can take the form of images, text, a graphical user interface (GUI), or other displayed content. As the herein described methods and processes change the data held by the storage subsystem 304, and thus transform the state of the storage machine, the state of display subsystem 306 can likewise be transformed to visually represent changes in the underlying data.

Display subsystem 306 can include one or more display devices utilizing virtually any type of technology. Such display devices can be combined with logic subsystem 302 and/or storage subsystem 304 in a shared enclosure, or such display devices can be peripheral display devices.

When included, input subsystem 308 can comprise or interface with one or more user-input devices such as a keyboard, mouse, touch screen, or joystick. In some embodiments, the input subsystem 308 can comprise or interface with selected natural user input (NUI) componentry. Such componentry can be integrated or peripheral, and the transduction and/or processing of input actions can be handled on- or off-board. Example NUI componentry can include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity. For example, input subsystem 308 can be configured to receive user inputs while performing the method 300 and/or displaying content.

When included, communication subsystem 310 can be configured to communicatively couple computing system 300 with one or more other computing devices. Communication subsystem 310 can include wired and/or wireless communication devices compatible with one or more different communication protocols. As non-limiting examples, the communication subsystem can be configured for communication via a wireless telephone network, or a wired or wireless local- or wide-area network. In some embodiments, communication subsystem 310 can allow computing system 300 to send and/or receive messages to and/or from other devices via a network such as the Internet. For example, communication subsystem 310 can be used receive or send data to another computing system. As another example, communication subsystem may be used to communicate with other computing systems during execution of method 300 in a distributed computing environment.

The following paragraphs provide additional support for the claims of the subject application. One aspect provides a method of upscaling video data, the method comprising: generating first resolution video data comprising a plurality of tiles that each comprise a plurality of pixels; determining whether a first tile of the plurality of tiles matches a previously-received version of the first tile; at least on condition that the first tile does not match the previously-received version of the first tile, upscaling the first tile from a first resolution to a second resolution greater than the first resolution; determining whether a second tile of the plurality of tiles matches a previously-received version of the second tile; and at least on condition that the second tile matches the previously-received version of the second tile, refraining from upscaling the second tile from the first resolution to the second resolution. The method may additionally or alternatively include, wherein determining whether the first tile matches the previously-received version of the first tile comprises comparing pixel values of the first tile to pixel values of the previously-received version of the first tile. The method may additionally or alternatively include, wherein comparing the pixel values of the first tile to the pixel values of the previously-received version of the first tile comprises comparing hashed pixel values of the first tile to hashed pixel values of the previously-received version of the first tile. The method may additionally or alternatively include, wherein the first tile comprises a first plurality of bits and the previously-received version of the first tile comprises a second plurality of bits, the method further comprising comparing a first subset of the first plurality of bits to a second subset of the second plurality of bits and refraining from comparing another subset of the first plurality of bits to a different subset of the second plurality of bits. The method may additionally or alternatively include, wherein determining whether the second tile matches a previously-received version of the second tile comprises: determining at least one difference between the second tile and the previously-received version of the second tile; determining that the at least one difference represents noise in the video data; and based at least in part on determining that the at least one difference represents noise in the video data, determining that the second tile matches the previously-received version of the second tile and refraining from upscaling the second tile from the first resolution to the second resolution. The method may additionally or alternatively include, wherein determining whether the first tile matches the previously-received version of the first tile comprises analyzing metadata associated with the first tile. The method may additionally or alternatively include, wherein analyzing the metadata comprises: identifying in the metadata at least one pixel difference in the first tile; and at least on condition of identifying the at least one pixel difference in the first tile, upscaling the first tile from the first resolution to the second resolution greater than the first resolution. The method may additionally or alternatively include, wherein a supertile of the first resolution video data comprises the first tile and a third tile, the method further comprising: determining whether any tiles that define the supertile do not match a previously-received version of that tile; and at least on condition that at least one tile that defines the supertile does not match a previously-received version of the at least one tile, upscaling all tiles that define the supertile from the first resolution to the second resolution.

Another aspect provides computing device, comprising: a processor; and memory storing instructions executable by the processor to: generate first resolution video data comprising a plurality of tiles that each comprise a plurality of pixels; determine whether a first tile of the plurality of tiles matches a previously-received version of the first tile; at least on condition that the first tile does not match the previously-received version of the first tile, upscale the first tile from a first resolution to a second resolution greater than the first resolution; determine whether a second tile of the plurality of tiles matches a previously-received version of the second tile; and at least on condition that the second tile matches the previously-received version of the second tile, refrain from upscaling the second tile from the first resolution to the second resolution. The computing device may additionally or alternatively include, wherein the instructions are executable to determine whether the first tile matches the previously-received version of the first tile by comparing pixel values of the first tile to pixel values of the previously-received version of the first tile. The computing device may additionally or alternatively include, wherein comparing the pixel values of the first tile to pixel values of the previously-received version of the first tile comprises comparing hashed pixel values of the first tile to hashed pixel values of the previously-received version of the first tile. The computing device may additionally or alternatively include, wherein the first tile comprises a first plurality of bits and the previously-received version of the first tile comprises a second plurality of bits, and the instructions are executable to compare a first subset of the first plurality of bits to a second subset of the second plurality of bits and refrain from comparing another subset of the first plurality of bits to a different subset of the second plurality of bits. The computing device may additionally or alternatively include, wherein determining whether the second tile matches a previously-received version of the second tile comprises: determining at least one difference between the second tile and the previously-received version of the second tile; determining that the at least one difference represents noise in the video data; and based at least in part on determining that the at least one difference represents noise in the video data, determining that the second tile matches the previously-received version of the second tile and refraining from upscaling the second tile from the first resolution to the second resolution. The computing device may additionally or alternatively include, wherein determining whether the first tile matches the previously-received version of the first tile comprises analyzing metadata associated with the first tile. The computing device may additionally or alternatively include, wherein analyzing the metadata comprises identifying in the metadata at least one pixel difference in the first tile, and at least on condition of identifying the at least one pixel difference in the first tile, upscaling the first tile from the first resolution to the second resolution greater than the first resolution. The computing device may additionally or alternatively include, wherein a supertile of the first resolution video data comprises the first tile and a third tile, and the instructions are executable to: determine whether any tiles that define the supertile do not match a previously-received version of that tile, and at least on condition that at least one tile that defines the supertile does not match a previously-received version of the at least one tile, upscale all tiles that define the supertile from the first resolution to the second resolution.

Another aspect provides a computing device configured to upscale video data, the computing device comprising: a display; a processor; and memory storing instructions executable by the processor to: generate first resolution video data comprising a plurality of tiles that each comprise a plurality of pixels; determine whether a first tile of the plurality of tiles matches a previously-received version of the first tile; at least on condition that the first tile does not match the previously-received version of the first tile, upscale the first tile from a first resolution to a second resolution greater than the first resolution and write the upscaled first tile to an output buffer to replace a prior upscaled version of the previously-received version of the first tile; determine whether a second tile of the plurality of tiles matches a previously-received version of the second tile; at least on condition that the second tile matches the previously-received version of the second tile, refrain from upscaling the second tile from the first resolution to the second resolution and maintain a prior upscaled version of the second tile in the output buffer; and write data from the output buffer including the upscaled first tile and the prior upscaled version of the second tile to the display. The computing device may additionally or alternatively include, wherein the instructions are executable to determine whether the first tile matches the previously-received version of the first tile comprises comparing pixel values of the first tile to pixel values of the previously-received version of the first tile. The computing device may additionally or alternatively include, wherein comparing the pixel values of the first tile to pixel values of the previously-received version of the first tile comprises comparing hashed pixel values of the first tile to hashed pixel values of the previously-received version of the first tile. The computing device may additionally or alternatively include, wherein the first tile comprises a first plurality of bits and the previously-received version of the first tile comprises a second plurality of bits, and the instructions are executable to compare a first subset of the plurality of bits to a second subset of the second plurality of bits and refrain from comparing another subset of the first plurality of bits to a different subset of the second plurality of bits.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method of upscaling video data, the method comprising:
generating first resolution video data comprising a plurality of tiles that each comprise a plurality of pixels;
determining whether a first tile of the plurality of tiles matches a previously-received version of the first tile;
at least on condition that the first tile does not match the previously-received version of the first tile, upscaling the first tile from a first resolution to a second resolution greater than the first resolution;
determining whether a second tile of the plurality of tiles matches a previously-received version of the second tile; and
at least on condition that the second tile matches the previously-received version of the second tile, refraining from upscaling the second tile from the first resolution to the second resolution.

2. The method of claim 1, wherein determining whether the first tile matches the previously-received version of the first tile comprises comparing pixel values of the first tile to pixel values of the previously-received version of the first tile.

3. The method of claim 2, wherein comparing the pixel values of the first tile to the pixel values of the previously-received version of the first tile comprises comparing hashed pixel values of the first tile to hashed pixel values of the previously-received version of the first tile.

4. The method of claim 2, wherein the first tile comprises a first plurality of bits and the previously-received version of the first tile comprises a second plurality of bits, the method further comprising comparing a first subset of the first plurality of bits to a second subset of the second plurality of bits and refraining from comparing another subset of the first plurality of bits to a different subset of the second plurality of bits.

5. The method of claim 1, wherein determining whether the second tile matches a previously-received version of the second tile comprises:
determining at least one difference between the second tile and the previously-received version of the second tile;
determining that the at least one difference represents noise in the video data; and
based at least in part on determining that the at least one difference represents noise in the video data, determining that the second tile matches the previously-received version of the second tile and refraining from upscaling the second tile from the first resolution to the second resolution.

6. The method of claim 1, wherein determining whether the first tile matches the previously-received version of the first tile comprises analyzing metadata associated with the first tile.

7. The method of claim 6, wherein analyzing the metadata comprises:
identifying in the metadata at least one pixel difference in the first tile; and
at least on condition of identifying the at least one pixel difference in the first tile, upscaling the first tile from the first resolution to the second resolution greater than the first resolution.

8. The method of claim 1, wherein a supertile of the first resolution video data comprises the first tile and a third tile, the method further comprising:
determining whether any tiles that define the supertile do not match a previously-received version of that tile; and
at least on condition that at least one tile that defines the supertile does not match a previously-received version of the at least one tile, upscaling all tiles that define the supertile from the first resolution to the second resolution.

9. A computing device, comprising:
a processor; and
memory storing instructions executable by the processor to:
generate first resolution video data comprising a plurality of tiles that each comprise a plurality of pixels;
determine whether a first tile of the plurality of tiles matches a previously-received version of the first tile;
at least on condition that the first tile does not match the previously-received version of the first tile, upscale the first tile from a first resolution to a second resolution greater than the first resolution;
determine whether a second tile of the plurality of tiles matches a previously-received version of the second tile; and
at least on condition that the second tile matches the previously-received version of the second tile, refrain from upscaling the second tile from the first resolution to the second resolution.

10. The computing device of claim 9, wherein the instructions are executable to determine whether the first tile matches the previously-received version of the first tile by comparing pixel values of the first tile to pixel values of the previously-received version of the first tile.

11. The computing device of claim 10, wherein comparing the pixel values of the first tile to pixel values of the previously-received version of the first tile comprises comparing hashed pixel values of the first tile to hashed pixel values of the previously-received version of the first tile.

12. The computing device of claim 10, wherein the first tile comprises a first plurality of bits and the previously-received version of the first tile comprises a second plurality of bits, and the instructions are executable to compare a first subset of the first plurality of bits to a second subset of the second plurality of bits and refrain from comparing another subset of the first plurality of bits to a different subset of the second plurality of bits.

13. The computing device of claim 9, wherein determining whether the second tile matches a previously-received version of the second tile comprises:
determining at least one difference between the second tile and the previously-received version of the second tile;
determining that the at least one difference represents noise in the video data; and
based at least in part on determining that the at least one difference represents noise in the video data, determining that the second tile matches the previously-received version of the second tile and refraining from upscaling the second tile from the first resolution to the second resolution.

14. The computing device of claim 9, wherein determining whether the first tile matches the previously-received version of the first tile comprises analyzing metadata associated with the first tile.

15. The computing device of claim 14, wherein analyzing the metadata comprises identifying in the metadata at least one pixel difference in the first tile, and at least on condition of identifying the at least one pixel difference in the first tile, upscaling the first tile from the first resolution to the second resolution greater than the first resolution.

16. The computing device of claim 9, wherein a supertile of the first resolution video data comprises the first tile and a third tile, and the instructions are executable to:
determine whether any tiles that define the supertile do not match a previously-received version of that tile, and
at least on condition that at least one tile that defines the supertile does not match a previously-received version of the at least one tile, upscale all tiles that define the supertile from the first resolution to the second resolution.

17. A computing device configured to upscale video data, the computing device comprising:
a display;
a processor; and
memory storing instructions executable by the processor to:
generate first resolution video data comprising a plurality of tiles that each comprise a plurality of pixels;
determine whether a first tile of the plurality of tiles matches a previously-received version of the first tile;
at least on condition that the first tile does not match the previously-received version of the first tile, upscale the first tile from a first resolution to a second resolution greater than the first resolution and write the upscaled first tile to an output buffer to replace a prior upscaled version of the previously-received version of the first tile;
determine whether a second tile of the plurality of tiles matches a previously-received version of the second tile;
at least on condition that the second tile matches the previously-received version of the second tile, refrain from upscaling the second tile from the first resolution to the second resolution and maintain a prior upscaled version of the second tile in the output buffer; and
write data from the output buffer including the upscaled first tile and the prior upscaled version of the second tile to the display.

18. The computing device of claim 17, wherein the instructions are executable to determine whether the first tile matches the previously-received version of the first tile comprises comparing pixel values of the first tile to pixel values of the previously-received version of the first tile.

19. The computing device of claim 18, wherein comparing the pixel values of the first tile to pixel values of the previously-received version of the first tile comprises comparing hashed pixel values of the first tile to hashed pixel values of the previously-received version of the first tile.

20. The computing device of claim 18, wherein the first tile comprises a first plurality of bits and the previously-received version of the first tile comprises a second plurality of bits, and the instructions are executable to compare a first subset of the plurality of bits to a second subset of the second plurality of bits and refrain from comparing another subset of the first plurality of bits to a different subset of the second plurality of bits.
